(19) United States
(12) Patent Application Publication
(10) Pub. No.: US 2026/0250163 A1
(43) Pub. Date: Aug. 27, 2026

(54) A TREATMENT METHOD OF AT LEAST ONE COLLOIDAL TOC PRESENT IN WASTEWATER

(71) Applicant: SNF Group, ANDREZIEUX BOUTHEON (FR)

(72) Inventors: Heung Seop LEE, ULSAN (KR); Young Han BAE, BUSAN (KR); Min Ho KIM, ULSAN (KR); Tae Seung HONG, BUSAN (KR); Jae Woo LEE, ULSAN (KR); Tae Kwang JEONG, GYEONGGI-DO (KR)

(73) Assignee: SNF Group, ANDREZIEUX BOUTHEON (FR)

(21) Appl. No.: 19/163,187

(22) PCT Filed: Mar. 8, 2024
(86) PCT No.: PCT/EP2024/056276

§ 371 Date: Sep. 8, 2025

(30) Foreign Application Priority Data
Mar. 9, 2023 (KR) 10-2023-0031407

(51) Int. Cl. C02F 1/56; C02F 1/66; C02F 101/30; C02F 101/32; C02F 103/28; C02F 103/32

(52) U.S. Cl. CPC C02F 1/56; C02F 1/66; C02F 2101/308; C02F 2101/32; C02F 2103/28; C02F 2103/32

(57) ABSTRACT

A treatment method of at least one colloidal TOC present in wastewater, said at least one colloidal TOC being selected among starch, oil, and dye, comprising the steps of:
(a) un-stabilizing the at least one colloid TOC by adding an alkaline source to the wastewater to raise the pH to 11 to 12.5;
(b) precipitating the at least one colloid TOC by adding a polymer flocculant; and
(c) separating the at least one precipitated colloid TOC into solid and liquid under conditions of pH 11 to 12.5 and discharging it out of the system.

### TECHNICAL FIELD

The present invention relates to a method for treating non-biodegradable TOC (Total Organic Carbon) sources for example in the papermaking wastewater and the reused water in the process, more specifically, to treatment technology for starch, oil, and dye which are the main substances responsible for colloidal TOCs, but which are not treated through the general process of coagulation and flocculation during the chemical treatment and have low biodegradability, and thus cause loads in the biological treatment process. The present invention aims to treat non-biodegradable TOC sources that accumulate without decomposition in continuous circulation within the system, although the treated water must be reused due to the nature of the paper making process, and through this, the present invention relates to a technology aimed at reducing odor in the paper making process, reducing the generation of foam, and improving productivity through improving chemical efficiency during the process.

### BACKGROUND ART

The conventional treatment method is generally a chemical treatment method, which consists of a process of adding inorganic coagulants such as alum, PAC (polyaluminum chloride), ferric chloride, and ferric sulfate to precipitate soluble COD sources through a coagulation reaction, flocculating by applying a polymer flocculant, and then separating into solid and liquid. Thereafter, it is common to apply various methods such as aerobic and anaerobic treatment as a biological treatment method, and to apply activated carbon adsorption, fenton oxidation, etc. as a third advanced treatment method. However, when applied in practice, there was a problem with the treatment efficiency of the TOCs being very low. In particular, there are large changes in inflow contaminant load efficiency, such as changes in waste paper usage rates and changes in process chemicals depending on the type of paper produced, and there is a large amount of polyvalent metal ions, which are the hardness sources such as the circulating process water, and under conditions of accumulation, there is a disadvantage that it causes a decrease in productivity and a decrease in the quality of the produced paper due to a decrease in reactivity with the polymer substances and other additives that are papermaking chemicals in the process.

In addition, due to continuous circulation within the system, since the starch among the non-biodegradable TOC sources, such as starch in the wastepaper and starch added to develop the strength of the paper during the process, cannot settle in the paper stock during the paper making process and is lost to the anaerobic decomposition of the white water, they lower the pH of the white water in the process, allowing more of the hardness source to dissolve, and the production of organic acids due to decomposition causes bad odors and the generation of foam in the process, and creates a vicious cycle that lowers the pH of the process water. In addition, the oil does not decompose and attaches to the paper stock, causing the paper break, or reduces the efficiency of process chemicals and becomes a causative agent that reduces the activity of microorganisms during the biological treatment process, and dyes, etc. are also attached together with starch and stabilized in a colloid state, causing problems.

To solve these problems, various wastewater treatment technologies have been developed, but the reality is that there are limits to improvement due to the nature of papermaking wastewater, which has large changes in actual properties and conditions and changes in load, and in particular, the development of treatment technology for the colloidal TOC sources has not been achieved, and due to this, it has problems such as causing a decrease in the efficiency of process chemicals, such as unexplained quality decline, paper break, and excessive foaming in the process.

Japanese Patent, J P 2017-001015 is a technology that removes phenol-based non-biodegradable pigments in drainage water to reduce chromaticity while also removing phenols and TOC components, but has limitations in selectivity for substances similar to phenol and in reducing non-biodegradable TOCs.

The International Publication, PCT/JP1997/001785 relates to a method for improving the dispersibility and suspension stability of bacterial cellulose as a simple and economical method of producing a cellulose concentrate with improved papermaking properties, dispersibility, suspension stability, and viscosity, and to a method for improving the papermaking properties of bacterial cellulose, which consists in concentrating an aqueous suspension of bacterial cellulose that has been subjected to disintegration treatment and then dispersing it again into an aqueous liquid, and to a bacterial cellulose concentrate thereof, but it uses bacteria to stabilize a suspension of cellulose, and thus it is a technology that solves the problem opposite to the present invention.

Japanese patent, 2012-143739 A relates to an effective treatment device and treatment method for the treated water with low COD concentration, low TOC concentration, and low dye concentration, which is a technology for the carrier of biological treatment and filtration method which use a granular material made of pumice as a biological support, a granular material made of diatomaceous earth as a biological support, and a non-woven fabric as a filter medium, but it has the problem of being limited to biodegradable TOCs.

Korean patent KR 10-1998-0085025 relates to a papermaking wastewater treatment method by irradiating electron beams to the papermaking wastewater and adding a flocculant to remove various harmful organic substances in the wastewater, which is a papermaking wastewater treatment method that decomposes or converts harmful substances in the papermaking wastewater by blowing a bubbling gas into the papermaking wastewater and irradiating it with electron beams generated from an electron beam accelerator, and which is a technology that can remove harmful substances in the papermaking wastewater with higher efficiency compared to conventional methods, but the decomposition characteristics caused by electron beam irradiation have limitations in treating the papermaking wastewater generated in large quantities, and require additional treatment of the decomposition products.

### DISCLOSURE

### Technical Problem

Accordingly, as a result of research and efforts to solve the above problems, the inventor of the present invention seeks to provide a treatment method for the removal of non-biodegradable colloidal TOC sources in the paper making process and wastewater.

### Technical Solution

According to the first aspect of the present disclosure, the present disclosure provides a treatment method of at least one colloidal TOC present in wastewater, especially originating from a paper making process or food industry, said colloidal TOCs being selected among starch (also referred to colloidal starch), oil, and dye and the method comprises the steps of un-stabilizing at least one colloidal TOC present in wastewater by adding an alkaline source to the waste water to raise the pH to 11 to 12.5; precipitating the at least one colloidal TOC by adding a polymer flocculant; and separating the at least one precipitated colloidal TOC into solid and liquid under conditions of pH 11 to 12.5 and discharging it out of the system.

According to the second aspect of the present disclosure, the present disclosure provides a treatment method of at least one colloidal TOC present in wastewater, especially originating from a paper making process or food industry, said colloidal TOCs being selected among starch (also referred to colloidal starch), oil, and dye and the method comprises the steps of removing the suspended solids (SS) by applying a polymer flocculant to the wastewater, or removing suspended solids (SS) and some dissolved organic substances by applying to the wastewater an inorganic coagulant and polymer flocculant; un-stabilizing the at least one colloidal TOC present in wastewater by adding an alkaline source to the waste water to raise the pH to 11 to 12.5; precipitating the at least one colloidal TOC by adding a polymer flocculant; separating the at least one precipitated colloidal TOC into solid and liquid under conditions of pH 11 to 12.5 and discharging it out of the system.

Advantageously, the inorganic coagulant is alum, PAC (polyaluminum chloride).

In a specific embodiment, the wastewater is originating from a recycled paper making process.

In a specific embodiment, the TOCs are a mixture of starch and oil.

### Advantageous Effects

According to the present invention, the present invention can treat non-biodegradable, stabilized colloidal TOC sources that accumulate without decomposition in continuous in-situ circulation in the paper making process or in food industry, which requires reuse of treated water due to its nature, and through this, can reduce odor, reduce the generation of foam, and improve chemical efficiency during the process.

### DESCRIPTION OF DRAWINGS

FIG. 1 is a graph of the reaction with colloidal TOC sources according to the input amount of alkaline chemicals.

FIG. 2 is a photograph showing the colloid state when treated with alkaline chemicals, treated with amphoteric polymer flocculant, and neutralized with acid.

FIG. 3 is a photograph showing the state of change in turbidity due to alkali treatment.

FIG. 4 is a graph of changes in pH and turbidity according to alkali treatment.

FIG. 5 is a photograph showing the state of change in turbidity due to alkaline treatment.

FIG. 6 is a graph of changes in pH and turbidity according to alkali treatment.

### BEST MODE

The terminology used herein is only intended to refer to specific examples and is not intended to limit the invention. As used herein, singular forms include plural forms unless phrases clearly indicate the contrary. As used in the specification, the meaning of “comprising” specifies particular features, areas, integers, steps, operations, elements and/or components, and does not exclude the presence or addition of other features, areas, integers, steps, operations, elements and/or components.

Although not otherwise defined, all terms including technical and scientific terms used herein have the same meaning as those generally understood by those skilled in the art in the technical field to which the present invention pertains. Terms defined in commonly used dictionaries are interpreted as having meanings consistent with related technical literature and currently disclosed content, and are not to be interpreted in an idealized or very formal sense unless otherwise defined.

Hereinafter, examples of the present invention will be described in detail so that those skilled in the art can easily implement the present invention. However, the present invention may be implemented in many different forms and is not limited to the examples described herein.

Typically, the process which is disclosed in the present specification relates to the treatment of wastewater originating from paper making process but may be extended to other fields like the treatment of wastewater originating from food industry.

In the present invention, the chemical treatment before the TOC removal process refers to a process of removing suspended solids (SS) by applying polymer flocculant alone to the raw wastewater in the water collection tank, or a process of removing colloidal TOCs after removing suspended solids (SS) and some dissolved organic substances by applying an inorganic coagulant and a polymer flocculant in parallel.

The biological treatment process is a process that decomposes and removes biodegradable TOC sources, which are organic substances, during the metabolic process of microorganisms. In general, various methods such as activated sludge process, A2O, and SBR have been developed, but in the case of wastewater containing colloidal TOCs, it is common for biological treatment efficiency to decrease during the biological treatment process, this is because the degradation of colloidal TOC sources is preferred over the degradation process by microorganisms of soluble TOC sources, or interfering forms and colloidal TOC sources are decomposed and become dissolved TOC sources or exist as low molecular weight colloidal TOC sources. For example, in the case of starch, due to its large molecular weight, its molecular weight decreases when decomposed by microorganisms, but it continues to exist as a TOC source, and in the case of oil, it attaches to the surface of microorganisms and becomes a causative agent that interferes with the material transfer and metabolism of microorganisms, and in the case of the dye, it attaches to starch and becomes a colloidal TOC source that inhibits both starch and oil due to its hydrophobic nature. Therefore, the present invention is a technology to maximize the treatment efficiency of TOC sources by eliminating colloidal TOC sources and improving the reduction in efficiency caused by colloidal TOC sources during the biological treatment process, which is a pretreatment process before the biological treatment.

In the present invention, the biological treatment refers to methods such as activated sludge process, A2O, and SBR.

The paper making process using general white water has a pH of 6.0 to 7.2, and the raw wastewater has a similar pH level. In the case of general wastewater treatment and in-process neutralization, there is a method of treating with alkali for the purpose of simple pH adjustment, in order to adjust the pH to the neutral range, or there is, in some cases, a treatment method for salting out that utilizes the characteristic that the solubility of metals decreases under alkaline conditions. However, when performing alkali treatment for the treatment of the organic substances, it is not treated at pH 8 or higher, and the general treatment method is to adjust the pH back to neutral for the chemical treatment after treatment.

In other words, the purpose of the above method is to precipitate the metal ions contained in the water by temporary adjusting the pH in such condition that metal ions are suspended in the water and then a polymer coagulant is added to form a precipitate. Such a process is used for treating wastewater for example from plating factory, wastewater from flue gas desulfurization, wastewater from a power plant, and wastewater from a garbage incinerator (see JP2019111513A). Such a process is also disclosed in KR101955048 which relates to a method of treating color filter wastewater and mixture of copper etching wastewater and aluminum etching wastewater.

In contrast, the purpose of the process of the invention is not to precipitate an inorganic metal by reversibly varying the pH, but to pre-treat colloidal TOCs like starch, which acts as a dry strength agent in recycled paper, colloidal starch, which is a decomposition product thereof, and lubricants discharged from machinery during the process. Thus, the present invention does not directly remove TOC, but pre-treats these colloidal starches and oils which exist as interfering substances in the general wastewater treatment process, which is the removal process of TOC.

According to the present invention, the treatment efficiency of the non-biodegradable TOCs, the turbidity removal efficiency and pH characteristics according to neutralization can be evaluated in order to evaluate applicability in unit processes such as the paper production process, the raw wastewater flowing into the wastewater treatment plant, the primary chemically treated water, and the secondary biologically treated water. Unlike adjusting the pH of the paper making process to 6.0~ 7.2 using white water, the present invention is characterized by simultaneous flocculation of un-stabilized colloidal starch, dye deposited on colloidal starch, oil solidified by saponification reaction, and hardness source with reduced solubility, by removing suspended solids (SS) from the incoming raw wastewater, and then adding alkaline chemicals to increase the pH to 11 or higher to un-stabilize the colloidal TOC sources, and flocculating by applying an amphoteric polymer flocculant in a high alkaline state without pH neutralization.

According to an essential feature of the process of the invention, the alkaline conditions are maintained until the treated water is discharged out. If the pH is neutralized in the meantime, the colloidal components are restabilized.

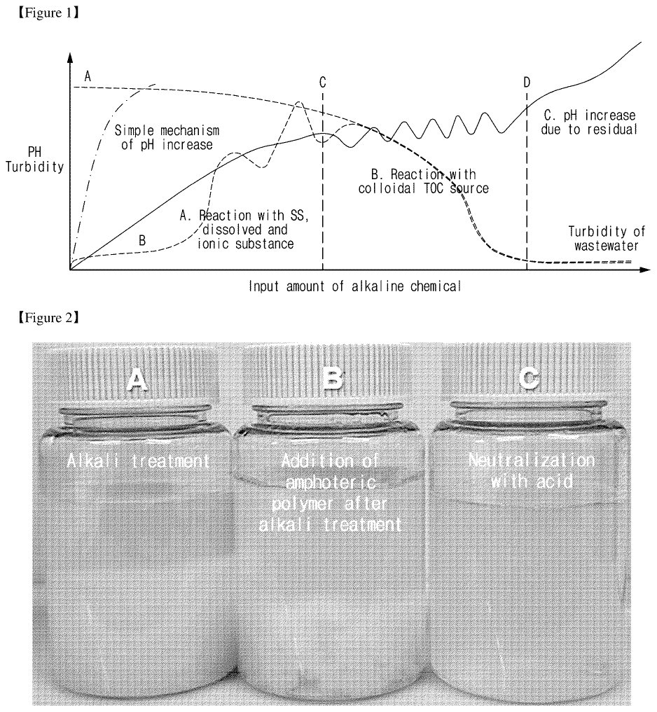

The reaction mechanism of the colloidal TOC sources with the source of alkalinity in the present invention is divided into a section where the pH increases in proportion to the input amount of alkaline chemicals when alkaline chemicals are added below C in FIG. 1, a colloid un-stabilization section of the colloidal TOC sources and the alkaline chemicals where the alkaline chemicals are consumed with almost no increase in pH even if the input amount of the alkaline chemicals is continuously increased as in the input amount section of alkaline chemicals from C to D, and a section where the pH rises proportionally again when the alkaline chemicals are added, as in input amount above D.

The pH adjustment in the present invention is a treatment method for un-stabilizing the colloidal TOCs that is stabilized and dispersed in water by adding alkaline chemicals to pH 11 or higher depending on the TOC sources present within the raw wastewater to precipitate colloid and dissolved TOCs, and performing flocculation treatment under high alkaline conditions without neutralization. In order to prevent the removal of colloidal TOCs from becoming impossible due to the property that un-stabilized colloidal TOC sources are re-stabilized when adjusted to pH 7-8 by neutralizing again as in C of FIG. 2, the pH range at the time of precipitation should be adjusted to 8 or more, or preferably 10.5 to 12.5. Since the precipitation conditions for the colloidal and dissolved TOCs are different, a treatment method according to their properties is an important technology.

Meanwhile, in the case where there are no colloidal TOC sources, if the alkaline chemicals are increased, the pH continues to rise, however, in the case where there are colloidal TOC sources, if the alkaline chemicals are increased, when the pH is above a certain pH as in sections C to D of FIG. 1, the main mechanism is to precipitate the colloidal TOC sources while the increase in pH is no longer large, or the pH is lowered or has no change, and in sections C to D, the alkaline chemicals are consumed due to continuous reactions and thus a reaction may occur that further lowers the pH.

This colloidal TOC removal mechanism exhibits two major change characteristics in turbidity. In the first change characteristic, the turbidity starts at high turbidity as in A of FIG. 1, and then there is no change in turbidity, and then the turbidity is rapidly decreased. In the second change characteristic, the turbidity shows a change in the form of continuously increasing from low turbidity as in B and then rapidly decreasing again. This is classified into form A, where it appears as if there is no change in turbidity when there is a substance causing high turbidity in the wastewater, but as the colloidal TOC sources are precipitated and precipitated, the turbidity is rapidly decreased, and form B, where only the colloidal TOC sources exist without a turbidity source, and then as the TOC sources are precipitated at the time of alkali treatment, the turbidity is rapidly increased, and when at pH levels above that, as precipitation is occurred, the turbidity is decreased.

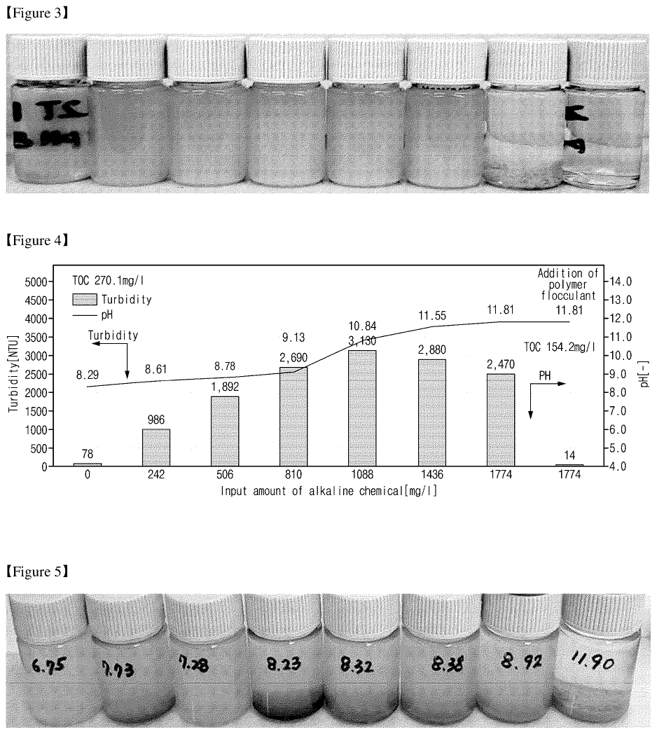

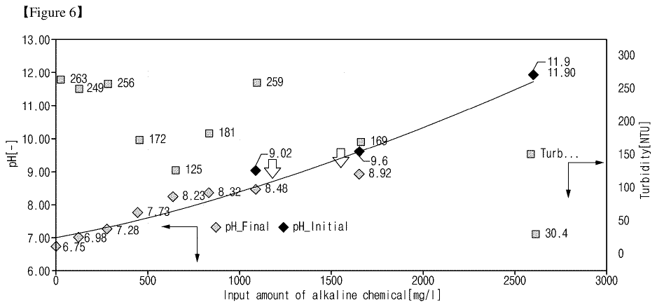

When testing the wastewater from which SS in the papermaking raw wastewater was removed, FIGS. 3 and 4 show that the initial turbidity is low, but the turbidity continues to increase during the alkali treatment, and then is rapidly decreased when a certain amount of alkali is added, and FIGS. 5 and 6 show that the turbidity was initially high, but the turbidity is changed and then is rapidly decreased to the same level when a certain amount of alkali is added. This is all caused by the induction of turbidity by precipitated colloids according to the reaction between the alkaline chemicals and the colloidal TOCs, and when the pH is above a certain level, the un-stabilized colloids are precipitated, thereby resulting in a sharp decrease in turbidity.

The reaction by the colloidal TOC removal technology of the present invention is a reversible reaction. Accordingly, when the pH is adjusted again with acid, it is re-stabilized and thus the precipitate is disappeared to form stabilized colloids. Therefore, in order for the present invention to be effective, the impact of their circulation can be eliminated only by discharging the colloid TOC sources out of the system through solid-liquid separation by applying sedimentation and pressure flotation and treating them separately, after flocculation by a polymer flocculant under conditions of pH 11 or higher. The polymer flocculant applied at this time is a general chemical treatment in which only anionic polymer flocculants with a (−) charge maintain their charge in alkaline conditions with a pH of 11 or higher. However, in the present invention, since the un-stabilized colloidal TOCs are a complex composition or a single composition of starch, oil, and dye, and the dissolved TOCs are also partially removed, both anionic and cationic flocculants can be applied, and most preferably, it is most efficient to apply an amphoteric polymer flocculant that has both (−) and (+) among polymer flocculants.

The precipitation is possible even without applying a flocculant under alkaline conditions of pH 11 or higher, but to increase the efficiency of the solid-liquid separation and reduce the processing time and the capacity of the facility, it is efficient to apply a polymer flocculant.

There may be differences in efficiency depending on the type and charge amount of the polymer flocculant, but it is not limited to the type. Preferably, an amphoteric polymer flocculant with 30 to 50 mol % of cationic content and 20 mol % or less of anionic content can be used for sediments of the colloidal TOC sources having a complex composition.

The types of alkaline chemicals are not limited to those types, and sodium hydroxide, calcium hydroxide, sodium aluminate, sodium bicarbonate, ammonium hydroxide, and ammonia can be used. It is possible with an alkaline treatment method that increases pH by adding the source of alkalinity in gas state. Preferably, in a way to suppress the increase in conductivity while lowering the hardness caused by calcium (Ca) in the process, the application of calcium hydroxide is most preferable. In some cases, it is possible to apply both single alkaline chemicals and mixed alkaline chemicals, such as the application of a mixture of sodium alginate and sodium hydroxide.

The input amount of the alkaline chemicals varies depending on the content of the colloidal TOC sources to be treated and the properties of the process water and wastewater to be treated. However, it is most efficient to adjust the pH to 10.5 or higher. Since colloidal TOC sources become unstable above pH 8 and cause turbidity, the input amount is not specified. However, based on the examples, it is preferably used in the range of 0.05 to 0.3% by weight based on sodium hydroxide. If the amount used is less than 0.05% by weight, there is no improvement effect because the removal efficiency of the colloidal TOC sources is low. If the amount used exceeds 0.3% by weight, unnecessary amounts are added, thereby making it less economical.

As an application method, a method is possible in which a portion of the white water flow within the paper making process is collected, treated with colloidal TOCs, and then introduced into the process, and it is performed in the form of processing the colloidal TOCs as pre- or post-treatment at each stage of the water collection tank, the first, the second and the third treatment in the wastewater treatment process, or a method is possible in which some of the wastewater treatment process is collected, and then used to treat the colloidal TOCs, and mixed with reused water for reuse in the process, and so on. Preferably, it is the most efficient method to optimize the efficiency of the biological treatment by removing suspended solids (SS) by applying the polymer flocculant to the raw wastewater in the water collection tank, or removing suspended solids (SS) and some dissolved organic substances by applying an inorganic coagulant and polymer flocculant, and then passing the colloidal TOCs removal process (chemical treatment before TOCs removal process) and thereafter returning to the water collection tank (first chemical treatment), or by mixing the first chemical treatment with the biological treatment process, thereby lowering the processing load of the colloidal TOCs during the biological treatment process. The method of applying only the polymer flocculant to the raw wastewater is a method to reduce unnecessary consumption of the alkaline chemicals during alkali treatment due to a neutralization reaction with the components of the suspended solids (SS) and to increase the reaction efficiency with the colloidal TOC sources, and depending on the process, it may be applied without removing the suspended solids (SS) in the raw wastewater in the water collection tank.

By applying this colloidal TOC removal technology, it is also possible to treat the entire amount of wastewater generated and white water circulating within the process. However, preferably, if the treatment amount is greater than the accumulated amount in the system, the system can be continuously stabilized. In actual application, it has been confirmed that it is possible to stabilize the entire process within a certain period of time by treating only 5 to 20% of the amount of wastewater generated, but there is no limitation on the application capacity.

In the present invention, the type of wastewater is also not limited, and both starch-containing wastewater and process water can be applied.

As such, in order to prevent the problem of continuous circulation by un-stabilizing non-biodegradable colloidal TOC sources, thereby causing them to precipitate, and stabilizing them again when the pH is lowered, in the conventional TOCs treatment technology that uses alkaline chemicals in the treatment of wastewater and production process water containing starch, oil, and dyes as colloidal TOC sources, the present invention is a technology that can improve the accumulation of TOCs through circulation when reusing it, and the accumulation of organic acids, lowering of pH, and interference with the mechanism of action of process chemicals through acid fermentation following decomposition, by applying solid-liquid separation under an alkaline condition and thus removing the colloidal TOC sources, which are interfering substances in the physical, chemical, and biological treatment process, and thus the present invention can be applied in various industrial fields where the TOCs are high or the treatment efficiency is reduced by the colloidal TOCs.

### EXAMPLE

The TOCs after the first treatment and the turbidity after the first treatment refer to the concentration and turbidity of the TOCs after the treatment according to Comparative Examples or Examples, respectively.

The TOCs and the turbidity after the second treatment refer to the concentration and turbidity of the TOCs after applying Examples and Comparative Examples through the first treatment and going through the biological treatment.

In all the examples, the wastewater is originating from corrugated board.

In all the examples, except examples 15 and 17, the TOCs are a mixture of starch and oil.

### Comparative Example 1

As a chemical treatment at the rear of the water collection tank, 500 mg/l of PAC was added and NaOH was added to adjust the pH to 7, and then an anionic polymer flocculant was added to prepare a first treated water. thereafter, the biological treatment was performed on the first treated water, and then the treated water was reused in the process.

### Comparative Examples 2 to 4

The same method as in Comparative Example 1 was carried out, except that in Comparative

Example 1, PAC is increased to 1,000, 1,500, and 2,000 mg/l as the first treatment, and the input amount of NaOH and flocculation agent is adjusted proportionally.

### Examples 1 to 3

The pH was adjusted to 11.4 by adding 0.15% by weight of NaOH for 10% of the flow rate in the raw wastewater, and EM533 (70/30 AM/AA.Na) as an anionic polymer flocculant, C-540CT (50/50 AM/ADAME.Quat) as a cationic polymer flocculant, and F-540HIB (40/50/10 AM/ADAME.Quat/AA.Na) as an amphoteric polymer flocculant were applied respectively, and after flocculation, the colloidal TOCs were collected as scum, dehydrated, and removed to produce a first treated water. After the biological treatment was applied to the first treated water, the treated water was reused in the process.

### Examples 4 to 6

As a chemical treatment at the rear of the water collection tank, 500 mg/l of PAC was added, and thus coagulation was performed by chemical treatment, and after removing the suspended matter by applying a polymer flocculant, the pH was adjusted to 11.4 by adding 0.15% by weight of NaOH for 10% of the flow rate. EM533 as an anionic polymer flocculant, C-540CT as a cationic polymer flocculant, and F-540HIB as an amphoteric polymer flocculant were applied respectively, and thus the flocculation was performed, and then through pressure flotation, the colloidal TOCs were collected as scum and removed by dehydration to prepare primary treated water. After the biological treatment was applied to the first treated water, the treated water was reused in the process.

### Examples 7 to 11

As a chemical treatment at the rear of the water collection tank, 500 mg/l of PAC was added, and thus coagulation was performed by chemical treatment, and after removing the suspended matter by applying a polymer flocculant, the alkali treatment was performed by adding 0.05, 0.1, 0.2, 0.25, and 0.3% by weight of NaOH for 10% of the flow rate. F-540HIB as an amphoteric polymer flocculant was applied respectively, and thus the flocculation was performed, and then through pressure flotation, the colloidal TOCs were collected as scum and removed by dehydration to prepare the first treated water. After the biological treatment was applied to the first treated water, the treated water was reused in the process.

TABLE 1
Evaluation of biological treatment efficiency according to
removal of colloidal TOC sources by alkaline treatment.

| | | TOC after | | TOC after | | |
|---|---|---|---|---|---|---|
| | Content of | first | Turbidity | second | Turbidity | TOC |
| | change | treatment | after first | treatment | after second | removal |
| Item | condition | (mg/l) | treatment | (mg/l) | treatment | efficiency |
| Comparative | 500 mg/l of PAC | 1560 | 298 | 847 | 121 | 45.7% |
| Example 1 | | | | | | |
| Comparative | Increase in | 1,540 | 283 | 831 | 109 | 46.0% |
| Example 2 | amount to PAC | | | | | |
| | 1,000 mg/l | | | | | |
| Comparative | Increase in | 1,531 | 308 | 834 | 112 | 45.5% |
| Example 3 | amount to PAC | | | | | |
| | 1,500 mg/l | | | | | |
| Comparative | Increase in | 1,533 | 321 | 829 | 108 | 45.9% |
| Example 4 | amount to PAC | | | | | |
| | 2,000 mg/l | | | | | |
| Example 1 | Flocculation | 1,502 | 94 | 512 | 43 | 65.9% |
| | treatment by | | | | | |
| | anionic polymer | | | | | |
| | after raw water | | | | | |
| | colloid treatment | | | | | |
| Example 2 | Flocculation | 1,498 | 83 | 488 | 22 | 67.4% |
| | treatment by | | | | | |
| | cationic polymer | | | | | |
| | after raw water | | | | | |
| | colloid treatment | | | | | |
| Example 3 | Flocculation | 1,478 | 64 | 465 | 14 | 68.5% |
| | treatment by | | | | | |
| | amphoteric | | | | | |
| | polymer after | | | | | |
| | raw water | | | | | |
| | colloid treatment | | | | | |
| Example 4 | Anionic polymer | 1,452 | 25 | 412 | 24 | 71.6% |
| | treatment after | | | | | |
| | PAC treatment | | | | | |
| | colloid treatment | | | | | |
| Example 5 | Cationic | 1,433 | 21 | 398 | 10.3 | 72.2% |
| | polymer | | | | | |
| | treatment after | | | | | |
| | PAC treatment | | | | | |
| | colloid treatment | | | | | |
| Example 6 | Amphoteric | 1,398 | 13 | 392 | 8.2 | 72.0% |
| | polymer | | | | | |
| | treatment after | | | | | |
| | PAC treatment | | | | | |
| | colloid treatment | | | | | |
| Example 7 | In Example 4, | 1,528 | 199 | 634 | 83 | 58.5% |
| | colloid treatment | | | | | |
| | with 0.05% | | | | | |
| | NaOH | | | | | |
| Example 8 | In Example 4, | 1,514 | 132 | 576 | 62 | 62.0% |
| | colloid treatment | | | | | |
| | with 0.1% | | | | | |
| | NaOH | | | | | |
| Example 9 | In Example 4, | 1,411 | 10 | 145 | 9.4 | 89.7% |
| | colloid treatment | | | | | |
| | with 0.2% | | | | | |
| | NaOH | | | | | |
| Example 10 | In Example 4, | 1,342 | 8.3 | 118 | 5.4 | 91.2% |
| | colloid treatment | | | | | |
| | with 0.25% | | | | | |
| | NaOH | | | | | |
| Example 11 | In Example 4, | 1,313 | 6.5 | 96 | 2.1 | 92.7% |
| | colloid treatment | | | | | |
| | with 0.3% | | | | | |
| | NaOH | | | | | |

### Comparative Example 1

When treating the wastewater containing the colloidal TOC sources according to Example 1, the TOCs removal rate and turbidity removal rate were measured to be 45.7% and 59.4% after the second treatment.

### Comparative Examples 2 to 4

As in Comparative Examples 2 to 4, even if the input amount of PAC as an inorganic coagulant applied to the chemical treatment is continuously increased from 500 mg/l to 2,000 mg/l, the treatment efficiency is not treated without a significant difference, with the TOCs removal rate being at the level of 46%. Therefore, it was confirmed that there is a limit to improving the efficiency even if the biological treatment is performed after the general chemical treatment.

### Examples 1 to 3

It was confirmed that as a result of adding 0.15% by weight of alkali to the same raw wastewater as in Comparative Example 1 to destabilize the colloidal TOCs, and thus performing the precipitation, and then adding anionic, cationic, and amphoteric polymer flocculants, respectively, the reduction of TOCs during the first chemical treatment process is as low as 5% compared to Comparative Example 1 (3.7%, 4.0%, and 5.2%, respectively), but after the second treatment, the TOCs removal rate of the second treated water is 65.9~68.5%, which is an improvement of more than 20% compared to Comparative Example 1. This means that although the removal of the dissolved TOCs is not significant through alkaline treatment, the efficiency can be increased by lowering the load caused by the colloidal contaminants during the biological treatment process through the removal of the colloidal TOC sources. In addition, it was confirmed that in the case of Example 3 where the amphoteric polymer flocculant is applied, since the colloids may be un-stabilized and removed in the form of either anionic or cationic properties depending on the ionic species during the alkali treatment, the colloidal TOC sources are un-stabilized from uncharged stabilized colloids and at the same time, are flocculated and precipitated together with other ionic substances, thereby showing the highest TOC removal efficiency.

### Examples 4 to 6

It was confirmed that the concentration of the TOCs after the first treatment according to Example 4 is improved by 6.9% compared to Comparative Example 1, which is also improved by 3.2% compared to the concentration of the TOCs after the first treatment according to Example 1. In addition, it was confirmed that the turbidity after the first treatment was improved by 91.6% compared to Comparative Example 1, and is also improved by 23.2% compared to the turbidity after the first treatment according to Example 1. In this way, Table 2 shows the comparison of Example 5 with Comparative Example 1 and Example 2, and the comparison of Example 6 with Comparative Example 1 and Example 3.

TABLE 2

| | | | TOC | | Turbidity | |
|---|---|---|---|---|---|---|
| | | | improvement | | improvement | |
| | TOC after | | rate | Difference in | rate | Difference in |
| | first | Turbidity | compared to | TOC | compared to | turbidity |
| | treatment | after first | Comparative | improvement | Comparative | improvement |
| | (mg/l) | treatment | Example 1 | rate | Example 1 | rate |
| Comparative | 1560 | 298 | | | | |
| Example 1 | | | | | | |
| Example 1 | 1,502 | 94 | 3.7% | | 68.5% | |
| Example 2 | 1,498 | 83 | 4.0% | | 72.1% | |
| Example 3 | 1,478 | 64 | 5.3% | | 78.5% | |
| Example 4 | 1,452 | 25 | 6.9% | 3.2% | 91.6% | 23.2% |
| Example 5 | 1,433 | 21 | 8.1% | 4.2% | 93.0% | 24.5% |
| Example 6 | 1,398 | 13 | 10.4% | 5.1% | 95.6% | 17.1% |

It was confirmed that the concentration of the TOCs after the second treatment according to Example 4 is improved by 51.4% compared to Comparative Example 1, which is further improved by 11.8% compared to the concentration of the TOCs after the second treatment according to Example 1. In addition, it was confirmed that the turbidity after the second processing is improved by 80.2% compared to Comparative Example 1, and is further improved by 15.7% compared to the turbidity after the first processing according to Example 1. In this way, Table 3 shows the comparison of Example 5 with Comparative Example 1 and Example 2, and the comparison of Example 6 with Comparative Example 1 and Example 3.

TABLE 3

| | TOC | | TOC | | Turbidity | |
|---|---|---|---|---|---|---|
| | after | Turbidity | improvement | Difference | improvement | Difference in |
| | second | after | rate compared | in TOC | rate compared | turbidity |
| | treatment | second | to Comparative | improvement | to Comparative | improvement |
| | (mg/l) | treatment | Example 1 | rate | Example 1 | rate |
| Comparative | 847 | 121 | | | | |
| Example 1 | | | | | | |
| Example 1 | 512 | 43 | 39.6% | | 64.5% | |
| Example 2 | 488 | 22 | 42.4% | | 81.8% | |
| Example 3 | 465 | 14 | 45.1% | | 88.4% | |
| Example 4 | 412 | 24 | 51.4% | 11.8% | 80.2% | 15.7% |
| Example 5 | 398 | 10.3 | 53.0% | 10.6% | 91.5% | 9.7% |
| Example 6 | 392 | 8.2 | 53.7% | 8.6% | 93.2% | 4.8% |

### Examples 7 to 11

It was confirmed that in the case of Examples 7 and 8, the alkaline chemicals were not added in an absolute amount that could sufficiently destabilize the colloidal TOC source, and thus the TOC removal efficiency is low due to the influence of residual colloidal TOC sources (Removal efficiencies: 58.5% and 62.0%). It was confirmed that in the case of Example 9, when adding 0.2% by weight of the alkaline chemicals, the TOC removal rate of the second treated water is improved to 90% or more, up to 92.7%, and approximately 47% is further removed compared to 45.7% in Comparative Example 1, and the removal efficiency is improved by more than two times. In the case of Examples 10 and 11, the increase rate of TOC removal efficiency was low, as compared to the effect of increasing the input amount of the alkaline chemicals, and when mixing with existing first chemical treated water to increase the consumption of the alkaline chemicals and to input the colloid treated water into the downstream process, since the pH is increased, the neutralization by an additional acid material is required, which may be undesirable. Therefore, it was confirmed that the desirable NaOH input amount is 0.1 to 0.2% compared to 10% of the flow rate of raw wastewater, and when re-neutralizing pH to neutral using acid again for downstream biological treatment while maintaining TOCs and turbidity removal efficiency, the neutralization is possible by merging with first chemically treated water without application of acid material.

It was confirmed that as a result of using the treated water as the process water in the paper production process, while removing the colloidal TOCs for 2 weeks using the method according to Example 9, mixing with first chemically treated water or the raw wastewater in the water collection tank, and treating using the existing processing method, as the colloidal TOC sources accumulated in the process water are removed, acid fermentation does not occur even in the paper production process under anaerobic conditions, and thus the pH of the white water in the process is maintained at 7 or more. In addition, stable application was possible without the generation of odor or foam caused by organic acids generated by acid fermentation, and the colloid treatment method of the present invention can be operated continuously, but when the accumulated colloidal TOC sources are small, it is treated for a certain period of time, and under low accumulation conditions, since the system is maintained in a stable state, it is judged that intermittent application is possible.

### Examples 12 to 14

These examples show the impact of the treatment according to the invention (colloid treatment) depending on the pretreatment which is performed (polymer flocculant or PAC) before the said colloid treatment.

TABLE 4

| | | TOC before | TOC after | |
|---|---|---|---|---|
| | Content of | colloid | colloid | TOC |
| | change | treatment | treatment | removal |
| Item | condition | (mg/l) | (mg/l) | efficiency |
| Example | original | 587.8 | 409.0 | 30.4% |
| 12 | wastewater | | | |
| Example | Wastewater after | 587.8 | 390.4 | 33.6% |
| 13 | removal of the | | | |
| | suspended solid | | | |
| | by applying a | | | |
| | polymer | | | |
| | flocculant | | | |
| Example | Wastewater after | 481.9 | 320.4 | 33.5% |
| 14 | PAC treatment | | | |
| | (500 mg/l PAC) | | | |

### Examples 15 to 17

These examples show the efficiency of the treatment whatever the nature of the wastewater.

TABLE 5

| | | | | TOC after |
|---|---|---|---|---|
| | | | | PAC |
| | | | TOC | treatment |
| | | TOC | after | (500 mg/l |
| | | before | PAC | PAC) + |
| | | any | treatment | colloid |
| | Wastewater | treatment | (500 mg/l | treatment |
| Item | type | (mg/l) | PAC) | (mg/l) |
| Example | Wastewater | 347.9 | 304.6 | 272.8 |
| 15 | from newspaper | | | |
| Example | Wastewater | 530.1 | 484.8 | 410.9 |
| 16 | from Corrugated | | | |
| | Board | | | |
| Example | Wastewater | 629.1 | 526.2 | 480.7 |
| 17 | from High | | | |
| | White Paper | | | |

1. A treatment method of at least one colloidal TOC present in wastewater, said at least one colloidal TOC being selected among starch, oil, and dye, comprising the steps of:
(a) un-stabilizing the at least one colloid TOC by adding an alkaline source to the wastewater to raise the pH to 11 to 12.5;
(b) precipitating the at least one colloid TOC by adding an amphoteric polymer flocculant; and
(c) separating the at least one precipitated colloid TOC into solid and liquid under conditions of pH 11 to 12.5 and discharging the at least one precipitated colloid TOC out of the system.

2. The treatment method of at least one colloidal TOC present in wastewater according to claim 1, wherein the source of alkalinity is at least one selected from sodium hydroxide, calcium hydroxide, sodium aluminate, sodium bicarbonate, ammonium hydroxide, and ammonia.

3. The treatment method of at least one colloidal TOC present in wastewater according to claim 1, wherein, before step (a), it comprises the steps of removing the suspended solids (SS) by applying a polymer flocculant to the wastewater, or removing suspended solids (SS) and some dissolved organic substances by applying to the wastewater an inorganic coagulant and polymer flocculant.

4. The treatment method of at least one colloidal TOC present in wastewater according claim 3, wherein the inorganic coagulant is alum, or polyaluminum chloride.

5. The treatment method of at least one colloidal TOC present in wastewater according to claim 1, wherein the wastewater is originating from a paper making process.

6. The treatment method of at least one colloidal TOC present in wastewater according to claim 5, wherein the wastewater is originating from a recycled paper making process.

7. The treatment method of at least one colloidal TOC present in wastewater according to claim 1, wherein the wastewater is originating from food industry.

8. The treatment method of at least one colloidal TOC present in wastewater according to claim 1, wherein the TOCs are a mixture of starch and oil.

9. The treatment method of at least one colloidal TOC present in wastewater according to claim 2, wherein, before step (a), it comprises the steps of removing the suspended solids (SS) by applying a polymer flocculant to the wastewater, or removing suspended solids (SS) and some dissolved organic substances by applying to the wastewater an inorganic coagulant and polymer flocculant.

10. The treatment method of at least one colloidal TOC present in wastewater according claim 9, wherein the inorganic coagulant is alum, or polyaluminum chloride.

11. The treatment method of at least one colloidal TOC present in wastewater according to claim 2, wherein the wastewater is originating from a paper making process.

12. The treatment method of at least one colloidal TOC present in wastewater according to claim 11, wherein the wastewater is originating from a recycled paper making process.

13. The treatment method of at least one colloidal TOC present in wastewater according to claim 3, wherein the wastewater is originating from a paper making process.

14. The treatment method of at least one colloidal TOC present in wastewater according to claim 13, wherein the wastewater is originating from a recycled paper making process.

15. The treatment method of at least one colloidal TOC present in wastewater according to claim 4, wherein the wastewater is originating from a paper making process.

16. The treatment method of at least one colloidal TOC present in wastewater according to claim 15, wherein the wastewater is originating from a recycled paper making process.

17. The treatment method of at least one colloidal TOC present in wastewater according to claim 2, wherein the wastewater is originating from food industry.

18. The treatment method of at least one colloidal TOC present in wastewater according to claim 3, wherein the wastewater is originating from food industry.

19. The treatment method of at least one colloidal TOC present in wastewater according to claim 4, wherein the wastewater is originating from food industry.

20. The treatment method of at least one colloidal TOC present in wastewater according to claim 2, wherein the amphoteric polymer flocculant comprises 30 to 50 mol % of cationic content and 20 mol % or less of anionic content.
